(19) United States
(12) Patent Application Publication
(10) Pub. No.: US 2011/0163510 A1
(43) Pub. Date: Jul. 7, 2011

(54) Edging Seal Profile

(76) Inventor: Stephan Wedi, Emsdetten (DE)

(21) Appl. No.: 12/974,455

(22) Filed: Dec. 21, 2010

(30) Foreign Application Priority Data
Jan. 5, 2010 (DE) 20 2010 000 626.0
May 31, 2010 (EP) 10005626.6

(51) Int. Cl. F16J 15/02; B32B 37/12; B23P 11/00

(52) U.S. Cl. 277/644; 277/628; 277/650; 156/60; 29/428

(57) ABSTRACT

Edging seal profile for kitchen worktops and the like, which is equipped with a top layer. The edging seal profile comprises a hollow chamber profile, which is enclosed by one front wall leg and two substantially parallel limiting legs deployed at a distance from each other, and which can be filled with a plate element or with an insulation mass, wherein the limiting legs are connected with the front wall leg projecting at right angle, and its upper limiting leg forms on its upper side a supporting surface for the top layer, which is connected with the front wall leg.

The invention relates to an edging seal profile for kitchen worktops or sanitary fittings, such as washstands and the like, which are provided with a top layer made of a natural stone or ceramic plates.

Edging seal profiles are used to close up the sides of worktops in kitchens or in wet areas. On the one hand, they should prevent damage or scratches from being caused to these areas, and on the other hand they should also prevent contamination and penetration of moisture which is in particular visible in the area of the edges.

A similar edging seal profile is known for example from DE 20 2004 018 996 U1.

The goal of the present invention is to provide an edging seal profile which is equipped with a simple and durable edging seal that can be used in particular for wooden plates, or for plastic foam plate used kitchen worktops, washstands and the like.

This goal is achieved with an edging seal profile of the type mentioned in the introduction which is equipped with a hollow chamber enclosed by one front wall leg and two limiting legs which are substantially oriented in the same direction, deployed in parallel and at a distance between them, and which can be filled by a plate element or an insulating mass, whereby the limiting legs are connected with the front wall leg projecting at right angle, and the upper limiting leg forms on its upper side a supporting surface for the top layer, and is connected with the edge stop with the front wall leg for the top layer, which is connected with the front wall leg. It is preferred when the edge stop mentioned above is connected in one piece with the front wall leg.

A solution is provided at the same level when a profile chamber is provided which is on one side limited by a front wall leg and by a limiting leg, whereby the limiting leg is connected with the front wall leg projecting at right angle in its central region and the limiting forms on one upper side the supporting surface for the top layer, which is connected with the stop stud for the top layer, which is in turn connected with the front wall leg.

This creates an edging seal profile which has “two floors”, wherein a covered layer is formed, consisting of one plate element, together with one layer that is made of natural stone or ceramic plates, and which is positioned with the edging strop profile so that it is laterally covered.

The following forms proved to be advantageous for an edge stop:

When the edge stop is formed as a stop stud continuing from the front wall leg, or

when the edge sealing is formed as an L-shaped angled part which continues with the first L-shaped leg linearly on the upper limiting leg, whereby the front wall leg and the first L-shaped leg form an L-shaped configuration, and the other L-shaped leg forms the front stop.

The edging seal profile is preferably cut from a metal or a plastic extruded profile is used. However, a corresponding rolled metal profile can be also used.

In order to cover a cavity which may be present and which is created on the edge in the area of the stop, the edging sealing is provided with a rounded flanging profile. Moreover, the flanging profile can be also manufactured from another material than the edging seal profile. The flanging profile can thus be manufactured for example from a somewhat flexible plastic material, while the remainder of the profile is manufactured from metal.

The invention further relates to sealing of edges, which is created while using an edge sealing profile according to one of the characteristics described above. In this case, the edge end of a worktop that is made of wood is inserted into the profile cavity, or inserted in a form locking manner and held there, wherein additional adhesives or other fixing means are also used, which are preferably not visible from outside. The plate can be connected via an adhesive layer or via a mortar compensation layer with a coating that is deployed on top thereof.

Finally, it should be also pointed out that an edging seal can be additionally also equipped with a veneer element, which is preferably arranged in the region that is clamped by the L-shaped configuration with the first L-shaped leg and with the front wall leg.

Embodiments of the invention will now be disclosed in the description below. The figures shown in the drawings indicate in particular the following:

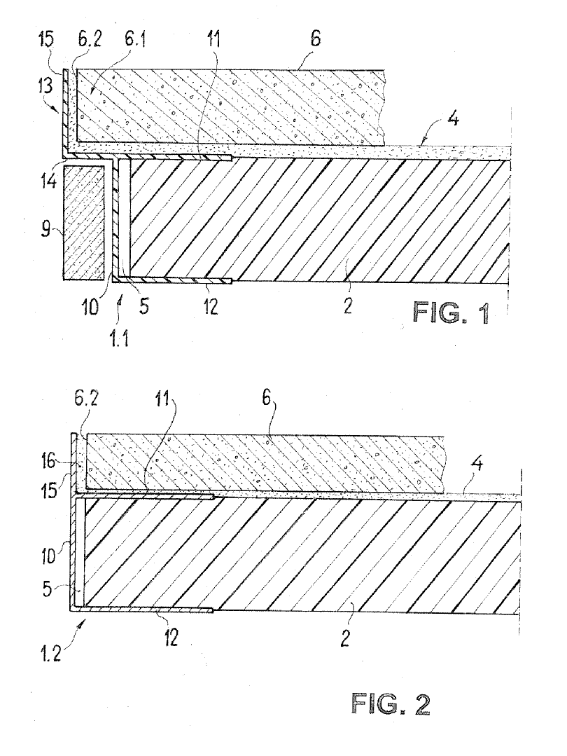

FIG. 1 a cross-section of one edging seal which is provided with an edging seal profile according to a first embodiment,

FIG. 2 a cross-section of a second embodiment which is similar to FIG. 1,

FIG. 3 an edging seal according to FIG. 1 provided with flanging in the stop region,

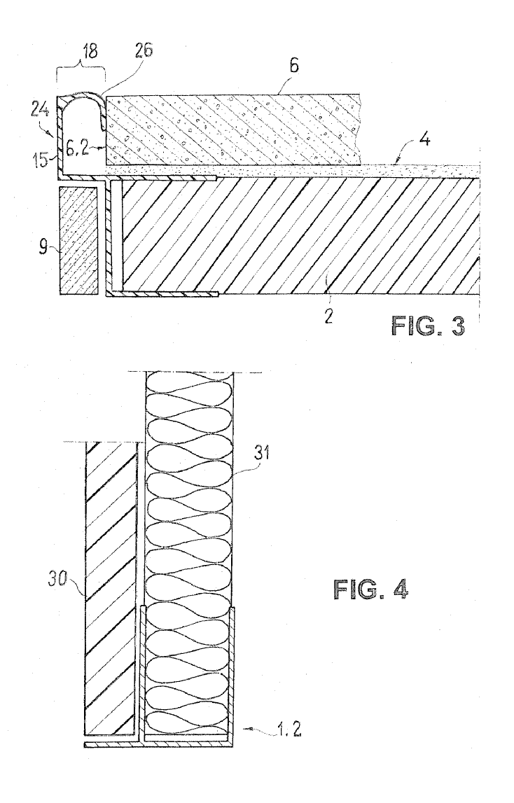

FIG. 4 a detail of a wall lining,

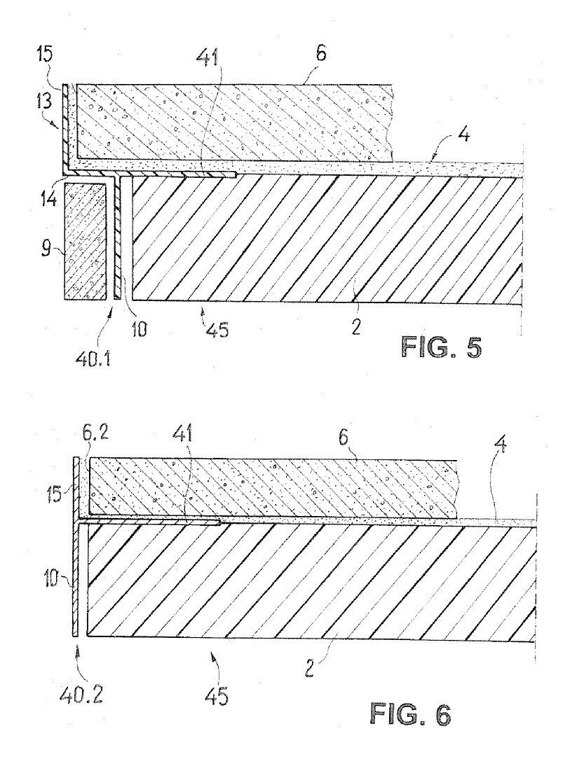

FIG. 5 cross-section of one edge seal, which is provided with an edge seal profile according to a third embodiment of this invention,

FIG. 6 a cross-section similar to FIG. 1, in a fourth embodiment,

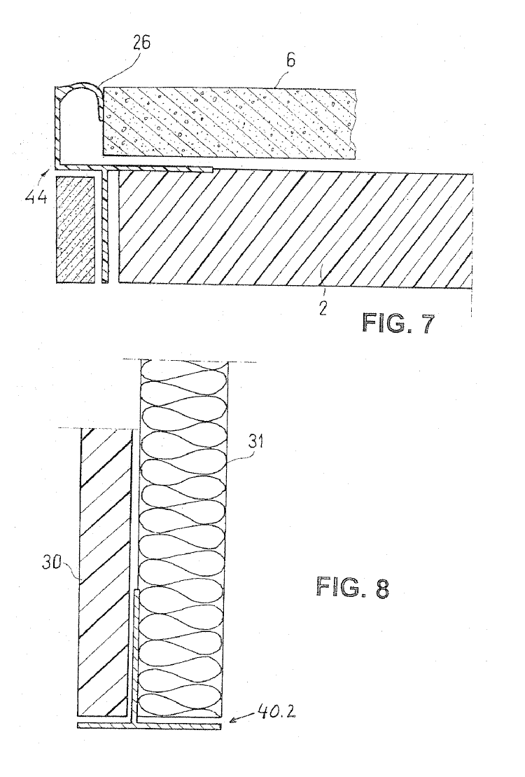

FIG. 7 edging seal according to FIG. 5, equipped with flanging in the stop region,

FIG. 8 a wall lining detail.

It should be pointed out that the terms “above” and “below” as used in the embodiments relate to the profiles shown in FIG. 1-3. However, similar types of edging seal profiles can be also used in another arrangement and position, for example as wall mounting fixtures (see FIG. 4).

Referring now to FIGS. 1 and 2, the figures indicate two usage types of the edging seal profile indicated by reference numerals 1.1 and 1.2; wherein a kitchen worktop is selected as the application area. The primary module is a foam plastic plate 2, made of XPS foam plastic material which is coated on its upper surface with a strong, hardened and reinforced mortar layer 4 that has a thickness of 0.5 to 2 mm. The foam plastic plate 2, which is partially indicated in FIGS. 1 and 2, is connected in a form-locking manner with the edging seal profile 1.1 and 1.2 by inserting it into a cavity 5. An adhesive can be also used in the cavity 5 when this is required.

The edging seal profile 1.1, which is indicated in FIG. 1, is first manufactured as an extrusion molding profile from a thermoplastic material, for example a polycarbonate.

The corresponding lengths are then cut depending on what the product is used for. The edging seal profile 1.1 results in the profile of a hollow chamber 5 which is enclosed by a front wall leg 10 and two limiting legs 11. The limiting legs are oriented in the same direction, deployed in parallel and at a distance from each other. The distance between the limiting legs 11 and 12 is determined by the thickness of the module which is to be supported, while the configuration of FIGS. 1 and 2 is applicable in a similar manner.

The upper side of the upper limiting leg 11 forms a relatively short supporting surface for the edge region 6.1 of a natural stone plate 6, which can be made for example from granite. In the space between the lower side of the natural stone plate 6 and the upper of the limiting leg 11 can be inserted a fixed adhesive mortar layer 4.

For the edging seal and the stop is used an L-shaped angle part 13, wherein the shorter L-shaped leg 14 is formed as a liner continuation of the upper limiting leg 11, so that the longer L-shaped leg forms an overhanging stop region with a stop stud 15 for the front wall leg 10. The adhesive and mortar layer 4 is continued in the inner space between the edge 6.2 and the longer L-shaped leg, that is to say the stop stud 15. Because a hardened mortar layer 4 is used which is characterized by durability and which can be reinforced, differences that are caused by elongation due to heat and corresponding expansion stress between the parts can be neutralized so that they will not be detrimental.

The edging seal profile 1.1 further also has the advantage that at least one veneer element 9 can be built into the region which is clamped by the L-shaped configuration from the L-shaped leg 14 and the front wall leg 10. A similar veneer element can consists of plastic strips or a number of tile elements.

As shown in FIG. 2, a wooden clamping plate is used as plate 2 here instead of the hard foam plastic plate. As shown in FIG. 2, the edging seal profile 1.2 is also provided with the profile of a hollow chamber 5, which is enclosed by a front wall leg 10 and two limiting legs 11 deployed at a distance from each other. The edging seal profile in one piece is provided with one edge stop, which is linearly continued from the front wall leg 10 and therefore continued to the stop stud 15.

The edging seal profile 1.2 is in this case manufactured from rolled steel with a cut profile configuration. The edge 6.2 of a washstand tile 6 is covered and protected. The thin bed mortar 4 is not continued all the way between the edge front surface in the stop stud 16 in the cavity 16.

FIG. 3 illustrates a modified configuration of an edging seal profile 24. The parts which are indicated with the same reference symbols correspond to the parts shown in FIG. 1.

In order to bridge over the gap 18 between the edge surfaces 6.2 and the inner side of the stop stud 15, a round flanging 26 is connected to the stop stud 15.

This can be formed by shaping or bending to create a corresponding extension of the stop stud 15.

However, it is also possible to attach flexible flanging, which can be made for example from PVC and which is connected with extrusion to the stop stud so that it is extended from its end. A better transition from the stop stud to the covering edge can thus be achieved both from the optical and tactile viewpoint.

Another embodiment of the invention is illustrated in the edging seal profiles shown in FIGS. 5 and 6 labeled by reference numerals 40.1 and 40.2. The selected application area is a washstand plate. The carrying module is a foam plastic plate 2 made of EPS foam material which is at least on its surface coated with a strong, hardened and reinforced mortar layer 4 having a thickness of 0.5 to 2 mm. The foam plastic plate 2, which is partially indicated in FIGS. 5 and 6, is inserted into the cavity 45 and connected with the edging seal profile 40.1 and 40.2. In the cavity 45, the foam plastic plate 2 is glued to the edging seal profile 40.1 and 40.2.

The edging seal profile 40.1 or 40.2, indicated in FIG. 5 or 6, is next manufactured as an extruded profile from a light metal alloy, for example Duralumin. The corresponding lengths are cut depending on the application. The edging seal profile 40.1 comprises the hollow profile chamber 45 which is limited by one front wall leg 10 and by the limiting leg 41. The length of the front wall leg 10 is determined by the thickness of the module to be supported, wherein the configuration shown in FIGS. 5 and 6 can be employed in a similar manner. The front wall leg 10 ends with one free lower end.

The upper side of the limiting leg 41 forms the supporting surface for a natural stone plate 6, made for example from stone material. In the area between the lower side of the natural stone plate 6 and the upper side of the limiting leg 41 is inserted a reinforced, thin-bed adhesive and mortar layer 4.

Similarly to the design indicated in FIG. 1, an L-shaped angle part profile 13 is used for the edging seal also as shown in FIG. 5, wherein the shorter L-shaped leg 14 is also formed as a linear continuation of the limiting leg 41, so that the longer L-shaped leg forms a stop area with an overhanging stop stud 15 for the front wall leg 10.

Instead of a hard foam plastic plate, a plate made from wood derivatives is used in FIG. 6, namely a hollow wooden clamped plate. As shown in FIG. 2, the edging seal profile 40.2 is also provided with the profile of a hollow chamber 45 which is clamped by one front wall leg 10 and by the limiting leg 41. The edging seal 40.2 which is designed as one piece has an edge stop, which is linearly continued from the front wall leg 10 to form the stop stud 15 in this manner.

The edging seal profile 40.2 is in this case manufactured in a cut configuration from a rolled fine steel profile. The edge 6.2 is covered and protected by a washstand tile 6. The thin-bed mortar 4 is not continued in the cavity 16 between the front surfaces of the edges in the stop stud 15.

FIG. 7 shows a modified configuration of an edging seal profile 44. The parts that are labeled with the same reference symbols correspond to the parts of FIG. 1.

A rounded flanging part 26 is connected to the stop stud 15 as was already explained with reference to FIG. 3.

The surface of respective integrated materials is roughened or structured as required. The possibilities in this case are well known to persons in the art, which is why they will not be explained here.

It should be pointed out (see FIGS. 4 and 8), that the described edging seal profile 1.2 or 40.2 can be also used for attachment of wall decoration plates 30 with a deposited self-supporting heat insulation plate 31 which serves as a self-supporting module. In this case, the edging seal profile 1.2 or 40.2 is employed as a supporting profile for wall lining.

1. An edging seal profile (1.1; 1.2, 24) for kitchen worktops, sanitary objects such as washstands and the like which is provided with a top layer (6, 30) made of natural stone plates or ceramic plates, characterized in that a hollow profile chamber (5), which is enclosed by one front wall leg (10) and two limiting legs (11; 12), which are substantially oriented in the same direction and deployed parallel and at a distance to each other and which can be filled by a plate element (2) or an insulation mass, wherein the limiting legs (11; 12) are connected with the front wall leg (1) deployed at a distance at right angle and form with the upper limiting leg (11) on its upper side a supporting surface for the top layer (6, 30) which is connected with a stop stud (15) for the top layer that is connected with the front wall leg (10).

2. The edging seal profile according to claim 1, characterized in that the stop stud (15) is connected in one piece with the front wall leg (10).

3. The edging seal profile according to claim 1, characterized in that a stop stud is designed as a stop stud (15) continuing from the front wall leg (10).

4. The edging seal profile according to claim 1, characterized in that one edging seal is linearly continued as an L-shaped angle part profile (13) with a first L-shaped leg (14) on the upper limiting leg (11), wherein the front wall leg (10) and the first L-shaped leg (14) form an L-shaped configuration, and the other L-shaped leg (15) forms the angle part profile (13) with the stop stud (15).

5. The edging seal profile according to claim 1, characterized in that one edging seal is linearly continued as an L-shaped angle part profile (13) with a first L-shaped leg (14) on the limiting leg (11), wherein the front wall leg (10) and the first L-shaped leg (14) form an L-shaped configuration, and the other L-shaped leg (15) of the angle part profile (13) form the stop stud (15).

6. The edging seal profile according to claim 1, characterized in that the edging seal profile (1.2; 1.2; 40.1; 40.2) is cut from a metal profile or from a molded plastic profile.

7. The edging seal profile according to claim 1, characterized in that the edging seal profile (1.2; 1.2; 40.1; 40.2) is cut from a metal profile or from a rolled metal profile.

8. The edging seal profile according to claim 1, characterized in that the free end of the stop stud (15) is provided with a rounded flanging profile (26).

9. The edging seal profile according to claim 8, characterized in that the fledging profile (26) is manufactured from a different material than the remaining material used in the edging seal profile.

10. An edging seal profile (40.1; 40.2) for kitchen worktops, sanitary objects such as washstands and the like which is provided with a top layer (6; 30) made of a natural stone plate or a ceramic plate, characterized by a profile chamber (45) which is limited on one side by one front wall leg (10) and one limiting leg (41),
wherein the limiting leg (41) is connected with the front wall leg (10) deployed at a distance and at right angle to the central area, and forms with the limiting leg (11) on its upper side a supporting surface for the top layer (6, 30), as well as a stop stud (15) for the top layer (15), which is connected with the front wall leg (10).

11. The edging seal profile according to claim 10, characterized in that the stop stud (15) is connected in one piece with the front wall leg (10).

12. The edging seal profile according to claim 10, characterized in that a stop stud is designed as a stop stud (15) continuing from the front wall leg (10).

13. The edging seal profile according to claim 10, characterized in that one edging seal is linearly continued as an L-shaped angle part profile (13) with a first L-shaped leg (14) on the upper limiting leg (11), wherein the front wall leg (10) and the first L-shaped leg (14) form an L-shaped configuration, and the other L-shaped leg (15) forms the angle part profile (13) with the stop stud (15).

14. The edging seal profile according to claim 10, characterized in that one edging seal is linearly continued as an L-shaped angle part profile (13) with a first L-shaped leg (14) on the limiting leg (11), wherein the front wall leg (10) and the first L-shaped leg (14) form an L-shaped configuration, and the other L-shaped leg (15) of the angle part profile (13) form the stop stud (15).

15. The edging seal profile according to claim 10, characterized in that the edging seal profile (1.2; 1.2; 40.1; 40.2) is cut from a metal profile or from a molded plastic profile.

16. The edging seal profile according to claim 10, characterized in that the edging seal profile (1.2; 1.2; 40.1; 40.2) is cut from a metal profile or from a rolled metal profile.

17. The edging seal profile according to claim 10, characterized in that the free end of the stop stud (15) is provided with a rounded flanging profile (26).

18. The edging seal profile according to claim 17, characterized in that the fledging profile (26) is manufactured from a different material than the remaining material used in the edging seal profile.

19. An edging seal manufactured while using an edging seal profile characterized in that in the profile cavity (5) of the edging end is inserted or inserted with a form-locking design a plate (2) which is made from wood, a wood derivative or foam plastic.

20. The edging seal according claim 19, characterized in that the plate (2) is connected via an adhesive layer or a mortar compensation layer (4) with a coating deployed on top thereof.

21. The edging seal according to claim 19, characterized in that the region, which is clamped by the L-shaped configuration comprising the first L-shape leg (14) and the front wall leg (10), is equipped with at least one veneer element (9).

22. The use of the edging seal profile (1.2; 40.2) as a supporting profile for wall lining.
